(19) United States
(12) Patent Application Publication
(10) Pub. No.: US 2013/0151084 A1
(43) Pub. Date: Jun. 13, 2013

(54) HANDS-FREE SYSTEM CONTROL METHOD FOR VEHICLE

(71) Applicant: Dae Hee Lee, Incheon (KR)

(72) Inventor: Dae Hee Lee, Incheon (KR)

(73) Assignees: Kia Motors Corp., Seoul (KR); Hyundai Motor Company, Seoul (KR)

(21) Appl. No.: 13/529,506

(22) Filed: Jun. 21, 2012

(30) Foreign Application Priority Data
Dec. 12, 2011 (KR) 10-2011-0133135

(51) Int. Cl. G06F 7/00

(52) U.S. Cl. 701/48; 701/1

(57) ABSTRACT

A hands-free system control method for a vehicle may include determining whether a variation in physical quantity may be sensed for a kick action of a user, and indicating that the kick action may be an invalid kick action, using a device that may be perceived by the user from the vehicle, when it may be determined that the sensed variation in the physical quantity may be invalid.

### CROSS-REFERENCE TO RELATED APPLICATIONS

The present application claims priority to Korean Patent Application No. 10-2011-0133135 filed on Dec. 12, 2011, the entire contents of which is incorporated herein for all purposes by this reference.

### BACKGROUND OF THE INVENTION

1. Field of the Invention

The present invention relates, in general, to a hands-free system control method for a vehicle and, more particularly, to a technology related to a hands-free system control method, which generates an open signal for a trunk or a tailgate only using the action of putting a foot in a space below a bumper without manipulating a switch manually, thus enabling the trunk or the tailgate to be automatically opened.

2. Description of Related Art

As shown in FIG. 1, a trunk or tailgate hands-free system is configured such that when a user performs a kick action of putting his or her foot 502 in a space below a rear bumper 500, this action is sensed by kick sensors installed on the lower and rear parts of a vehicle around the foot 502, and then a trunk or a tailgate can be automatically opened.

However, such a kick sensor is typically implemented as a capacitor sensor and is configured to determine the user's manipulation intention using a method of sensing a variation in measured physical quantity, such as a variation in capacitance appearing as the foot of the user approaches the kick sensor. However, it is difficult for the kick sensor to recognize the users' actions with 100% reliability for various types of environments that the vehicle can face and for kick actions of various users.

That is, in a vehicle, the degree to which a bumper and a lower part thereof are polluted differs from moment to moment, and weather variations such as in rainy weather occur. Further, due to various vehicle conditions such as whether a current condition corresponds to a condition after the vehicle has been washed, and whether the parked location of the vehicle is a slope way, variations in the physical quantity measured by the kick sensor can vary, even for the kick action made by the same user. Further, the user may have various physical conditions depending on whether the user is a child, elderly or weak, or a woman, and may wear various types of shoes, thus making it almost impossible in practice for the kick sensor to perfectly sense the actions of the user.

Furthermore, in order to guarantee the reliability of the user's manipulation, a sensor may be configured such that if even a slight variation in physical quantity is sensed, a trunk or a tailgate is opened. However, this configuration may cause a trunk or the like to be opened even in a situation in which the user does not perform a kick action, thus lessening the reliability of the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hands-free system control method for a vehicle, which is configured such that when a variation in physical quantity sensed by the kick action of a user does not reach a predetermined level and it is impossible to normally open a trunk or a tailgate, the fact that the kick action is an unsuitable kick action that cannot be automatically recognized is shown to the user, so that the advantage of inducing and teaching the user to conduct a suitable kick action can be obtained while improving the reliability of the vehicle felt by the user, thus ultimately enhancing the marketability of the vehicle.

In an aspect of the present invention, a hands-free system control method for a vehicle, may include determining whether a variation in physical quantity is sensed for a kick action of a user, and indicating that the kick action is an invalid kick action, using a device that is perceived by the user from the vehicle, when it is determined that the sensed variation in the physical quantity is invalid.

Whether the sensed variation in the physical quantity is invalid is determined when the variation in the physical quantity is less than a predetermined value

The determining whether the variation in the physical quantity for the kick action is sensed is performed, after performing sensing a smart key and then determining that the kick action is manipulation made by a valid user, and sensing the variation in the physical quantity using kick sensors.

The hands-free system control method may further include issuing a command to open a trunk or a tailgate when it is determined that the variation in the physical quantity sensed for the kick action of the user is valid, wherein whether the sensed variation in the physical quantity is valid is determined when the variation in the physical quantity is equal to or greater than a predetermined value.

The indicating that the kick action is the invalid kick action is configured to turn on and off a lamp of the vehicle and generate a beep sound.

At the indicating that the kick action is the invalid kick action, the device for indicating the invalid kick action may include a rear lamp and a horn, and at the indicating that the kick action is the invalid kick action, the rear lamp and the horn are operated for a predetermined period of time.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing the kick action of operating a conventional trunk hands-free system.

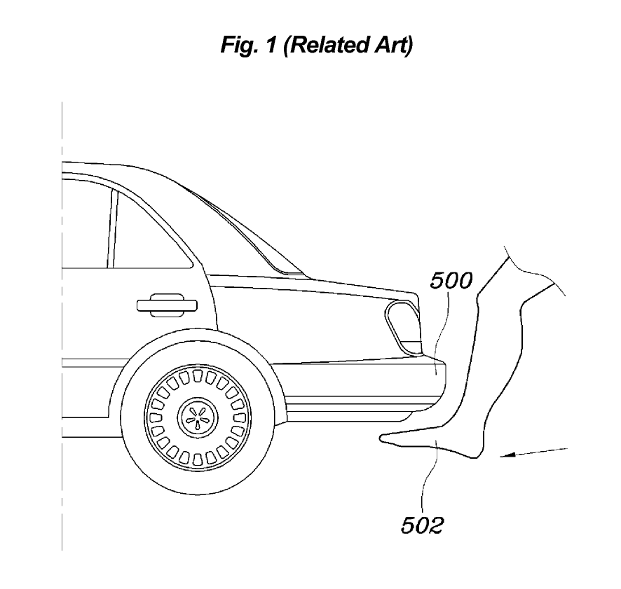

FIG. 2 is a flowchart showing an exemplary embodiment of a hands-free system control method for a vehicle according to an exemplary embodiment of the present invention.

FIG. 3 is a diagram showing an example of the construction of a hands-free system for a vehicle for implementing the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the attached drawings.

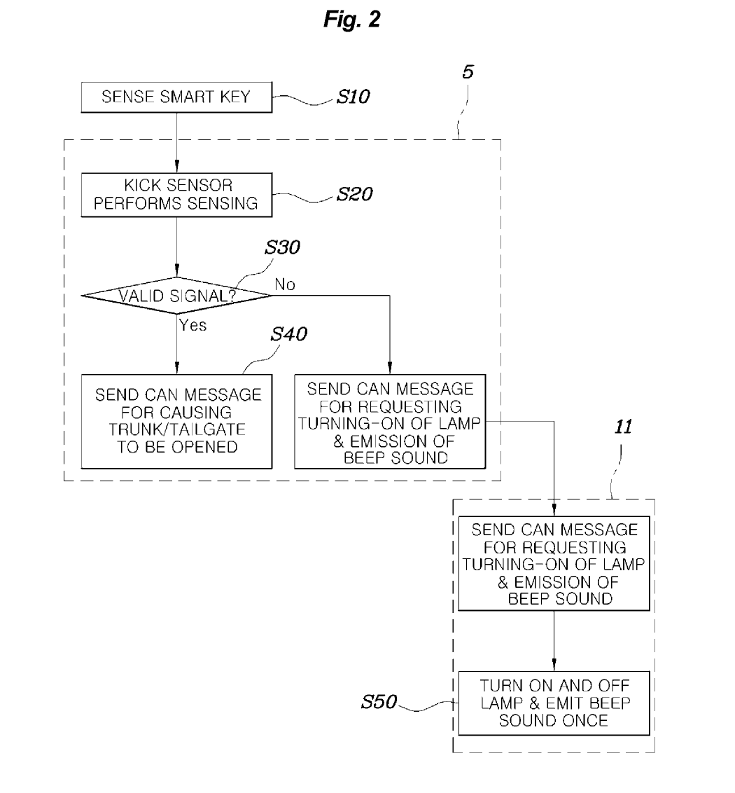

Referring to FIG. 2, an exemplary embodiment of a hands-free system control method for a vehicle according to an exemplary embodiment of the present invention includes the validity determination step S30 of determining whether a valid variation in physical quantity has been sensed for the kick action of a user, and the invalidity indication step S50 of, if it is determined at the validity determination step S30 that the sensed variation in physical quantity is not valid, indicating that the kick action is an invalid kick action by using a means that can be perceived by the user from a vehicle.

That is, in the case where a variation in physical quantity is sensed by kick sensors for the user's kick action, if the variation in physical quantity is equal to or greater than a predetermined value, it is determined that the kick action is a valid kick action, and a normal operation corresponding to the kick action is performed. If the variation in physical quantity does not reach the predetermined value, the invalidity indication step S50 is performed, thus allowing the user to personally perceive that the trunk or the tailgate is not automatically opened due to the user's erroneous kick action, and inducing the user to reattempt to conduct an accurate kick action. As a result, the method can enhance the reliability of the vehicle while inducing and teaching the user to conduct an accurate kick action.

The validity determination step S30 is preferably performed after the smart key sensing step S10 of sensing a smart key and determining that the kick action is manipulation made by a valid user, and the sensor sensing step S20 of sensing a variation in physical quantity using kick sensors.

That is, in the case of a vehicle equipped with a smart key system, it is more preferable to additionally check whether a user's request is a trunk or tailgate open request made by a proper user by determining whether the smart key is present behind the vehicle.

Of course, according to the type of vehicle, when a smart key system is not provided, the method may be configured such that the smart key sensing step S10 is omitted.

If it is determined at the validity determination step S30 that a valid variation in physical quantity has been sensed for the kick action of the user, the open commanding step S40 of issuing a command to open the trunk or the tailgate is performed.

At the invalidity indication step S50, the lamp of the vehicle may be turned on and off, and a beep sound may be generated. That is, at the invalidity indication step S50, only the lamp may be turned on and off, or only a beep sound or a horn sound may be emitted. This may be determined to be most suitable for a relevant vehicle type via reasonable selection.

Therefore, the means indicating that the kick action is an invalid kick action at the invalidity indication step S50 includes a rear lamp and a horn, so that the rear lamp and the horn may be operated for a predetermined period of time. Alternatively, it may also be possible to construct the means so that it notifies the user that the kick action is an erroneous attempt using a separate voice guidance device or the like and generates a guidance message for inducing the user to conduct an accurate kick action.

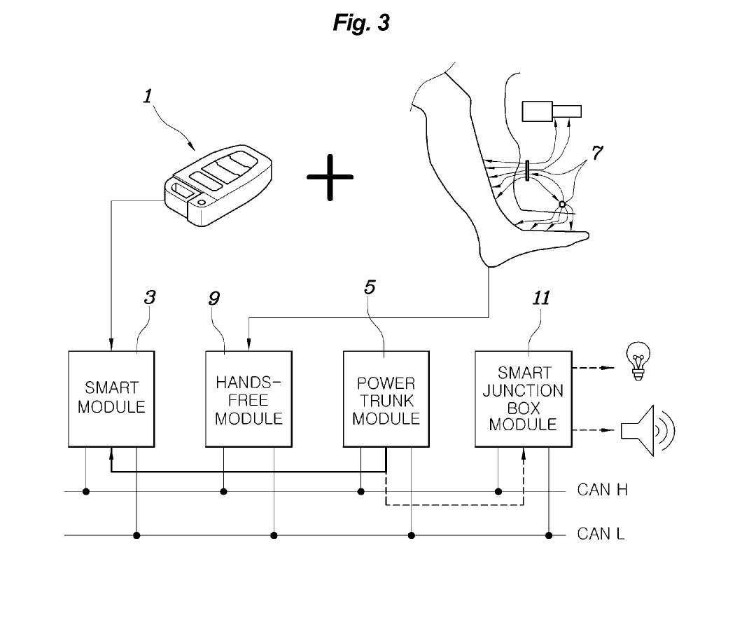

For reference, FIG. 3 illustrates a hands-free system for a vehicle that implements the method of the present invention in a vehicle equipped with a smart key system. When a user performs a kick action while carrying a smart key 1 with the user, the smart module 3 of the vehicle performs the smart key sensing step S10 while communicating with the smart key 1. The hands-free module 9 of the vehicle performs the sensor sensing step S20 of sensing the kick action of the user using kick sensors 7. If a valid kick action has been sensed, and then a Controller Area Network (CAN) message for requesting the trunk or the tailgate to be opened is sent, the smart module 3 receives the CAN message. If it is determined by the smart module 3 that the smart key is a proper smart key, a CAN message for causing the trunk to be opened is sent by a power trunk module 5. If an invalid kick action has been sensed and then the hands-free module 9 sends a CAN message for requesting the turning-on of the lamp and the emission of a beep sound, a smart junction box module 11 receives the CAN message, and then turns on and off the lamp, and emits a beep sound for a predetermined period of time, thus notifying the user that the kick action is an unsuitable action.

For reference, the predetermined period of time for which the beep sound is to be emitted may preferably be set to a relatively short time of less than 1 second. However, the predetermined period of time is not limited thereto, and may be variously changed such as by repeating the beep sound at short intervals.

As described above, the present invention is configured such that when a variation in physical quantity sensed by the kick action of a user does not reach a predetermined level and it is impossible to normally open a trunk or a tailgate, the fact that the kick action is an unsuitable kick action that cannot be automatically recognized is shown to the user, so that the advantage of inducing and teaching the user to conduct a suitable kick action can be obtained while improving the reliability of the vehicle felt by the user, thus ultimately enhancing the marketability of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hands-free system control method for a vehicle, comprising:
determining whether a variation in physical quantity is sensed for a kick action of a user; and
indicating that the kick action is an invalid kick action, using a device that is perceived by the user from the vehicle, when it is determined that the sensed variation in the physical quantity is invalid.

2. The hands-free system control method according to claim 1, wherein whether the sensed variation in the physical quantity is invalid is determined when the variation in the physical quantity is less than a predetermined value

3. The hands-free system control method according to claim 1, wherein the determining whether the variation in the physical quantity for the kick action is sensed is performed, after performing:
sensing a smart key and then determining that the kick action is manipulation made by a valid user; and
sensing the variation in the physical quantity using kick sensors.

4. The hands-free system control method according to claim 1, further including, issuing a command to open a trunk or a tailgate when it is determined that the variation in the physical quantity sensed for the kick action of the user is valid.

5. The hands-free system control method according to claim 4, wherein whether the sensed variation in the physical quantity is valid is determined when the variation in the physical quantity is equal to or greater than a predetermined value.

6. The hands-free system control method according to claim 1, wherein the indicating that the kick action is the invalid kick action is configured to turn on and off a lamp of the vehicle and generate a beep sound.

7. The hands-free system control method according to claim 1, wherein:
at the indicating that the kick action is the invalid kick action, the device for indicating the invalid kick action includes a rear lamp and a horn; and
at the indicating that the kick action is the invalid kick action, the rear lamp and the horn are operated for a predetermined period of time.
